(19) United States
(12) Patent Application Publication
(10) Pub. No.: US 2011/0283752 A1
(43) Pub. Date: Nov. 24, 2011

(54) COMPUTER CASING LOCK

(76) Inventor: Meir Avganim, M. P. Nachal Sorek (IL)

(21) Appl. No.: 13/132,887

(22) PCT Filed: Dec. 10, 2009
(86) PCT No.: PCT/IL2009/001170

§ 371 Date: Aug. 12, 2011

(30) Foreign Application Priority Data
Dec. 15, 2008 (IL) 195952

(51) Int. Cl. E05B 73/00

(52) U.S. Cl. 70/18; 70/14

(57) ABSTRACT

A locking device for box-shaped containers (20) having a base and a separable cover each provided with an ear-like extension (20c; 20d) with openings, wherein in the lockable position the openings are in register one with respect to the other. The device comprises a block-shaped housing (10) with a key-operated mechanism (30) comprising a rotor. A slidable locking element is coupled to the rotor so that upon rotation of the rotor by 180° in one or the opposite directions by turning the key, a locking element slides over a certain distance in one or the opposite directions. A cavity is formed in the housing configured to accommodate therein both ear-like extensions (20c; 20d). For locking the container, the locking element is driven in the direction of and across the cavity and openings.

### FIELD OF THE INVENTION

The present invention generally relates to locking devices, and in particular to locks for desktop computer casings.

### BACKGROUND OF THE INVENTION

Astonishing as it may seem to be in our modern, Hi-Tech era, is the fact that simple padlocks, one of the oldest human inventions, are still being used to lock many types of table computer casings.

Hence, referring to FIG. 1, there is shown a pair of projecting ears 1 and 2, forming part or otherwise affixed to computer casing or any other container such as a tool-box cover 3 and back wall 4, respectively. Aligned openings are formed in the ears 1 and 2 to receive therethrough yoke 5 of padlock body 6 operable by key 7 of a cylinder type locking mechanism.

It is therefore the general object of the present invention to devise a more safe, sophisticated, and user-friendly locking device for the purpose in question.

### SUMMARY OF THE INVENTION

According to the invention there is provided a locking device for box-shaped containers having a base and a separable cover each provided with an ear-like extension having an opening, wherein in the lockable position the openings are in register one with respect to the other and the container becomes locked by insertion of a locking element through both openings, the device comprising; a block-shaped housing; a key-operated rotor installed within the housing; a slidable locking element coupled to the rotor so that upon rotation of the rotor by 180° in one or the opposite directions by turning the key, the locking element slides over a certain distance in one or the opposite direction extending normally to the axial direction of the rotor; and a cavity formed in the housing configured to accommodate therein both said ear-like extensions when in overlapping position, the arrangement being such that for locking the container, the locking element is driven in the direction of and across said cavity and openings, and for unlocking, the locking element is driven in the opposite direction out of the said cavity.

### BRIEF DESCRIPTION OF THE DRAWINGS

These and additional features and advantages of the invention will become more clearly understood in the light of the following description of a preferred embodiment thereof, given by way of example only, with reference to the attached drawings, wherein—

FIG. 1 is a perspective view of a conventional padlock arrangement;

FIG. 2 is a general, schematic perspective view of a locking arrangement according to a preferred embodiment of the present invention;

FIG. 3 is an enlarged view of the locking arrangement of FIG. 2;

FIG. 4 is a view taken in the direction A-A of FIG. 3;

FIG. 5a is a sectional view taken along plane B-B of FIG. 3 in the unlocked position;

FIG. 5b is a sectional view taken along plane C-C of FIG. 5a.

FIG. 5c is a view taken along plane D-D of FIG. 3.

FIG. 6 depicts a first stage of locking the computer casing; and

FIG. 7 shows the completion of locking operation.

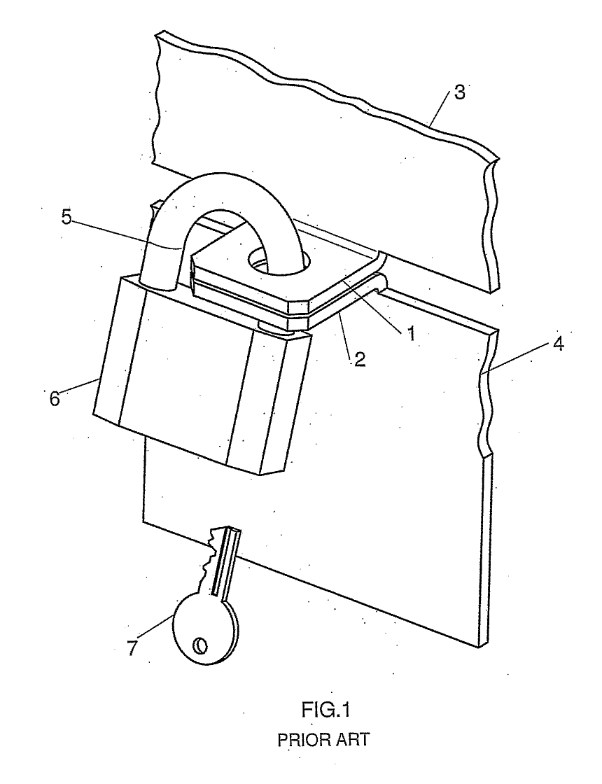

### DETAILED DESCRIPTION OF THE PREFERRED EMBODIMENTS

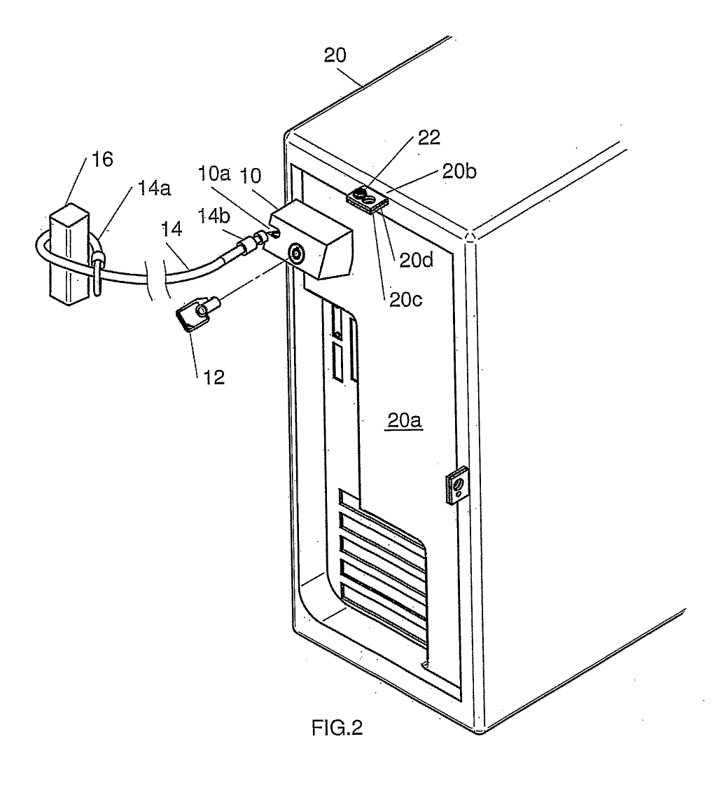

In FIG. 2, 10 denotes the novel lock-body, which is operable by key 12.

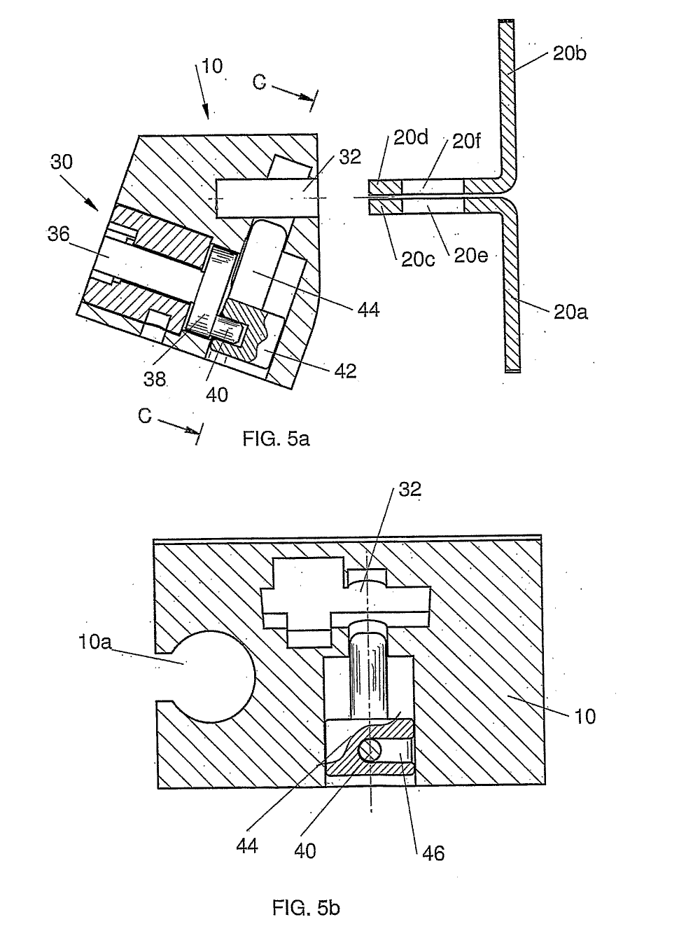

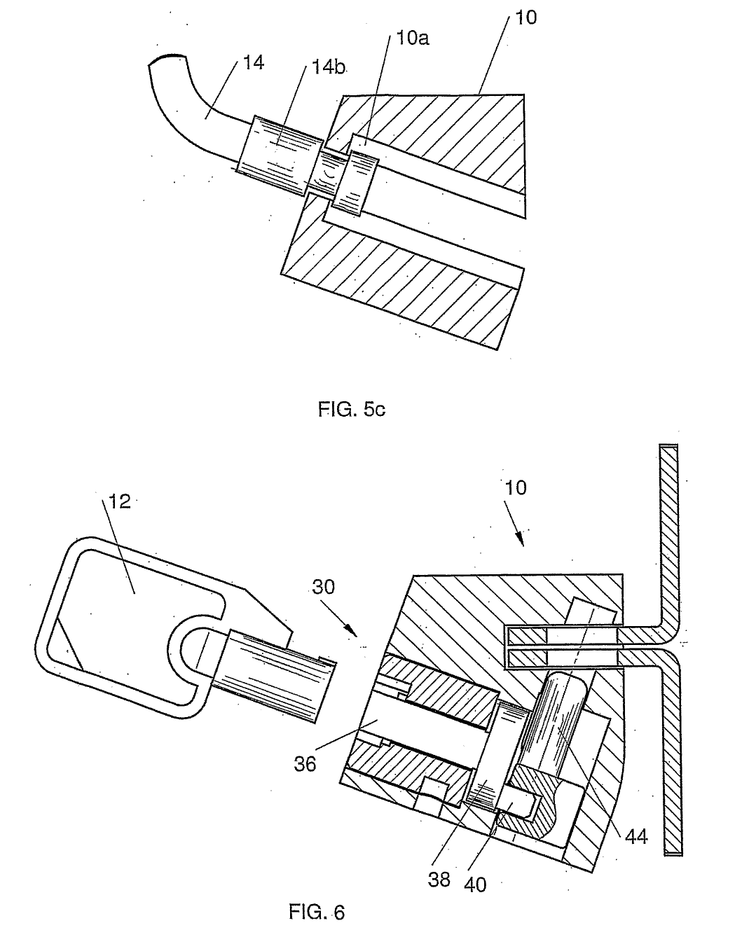

A security cable 14 is provided and used in the conventional manner, namely looped at one end 14a to a fixed object 16 and the other end adapted to be arrested to the lock body 10 by cable-head 14b fitting into groove 10a when the latter is locked against computer casing generally denoted 20 (see FIG. 5c).

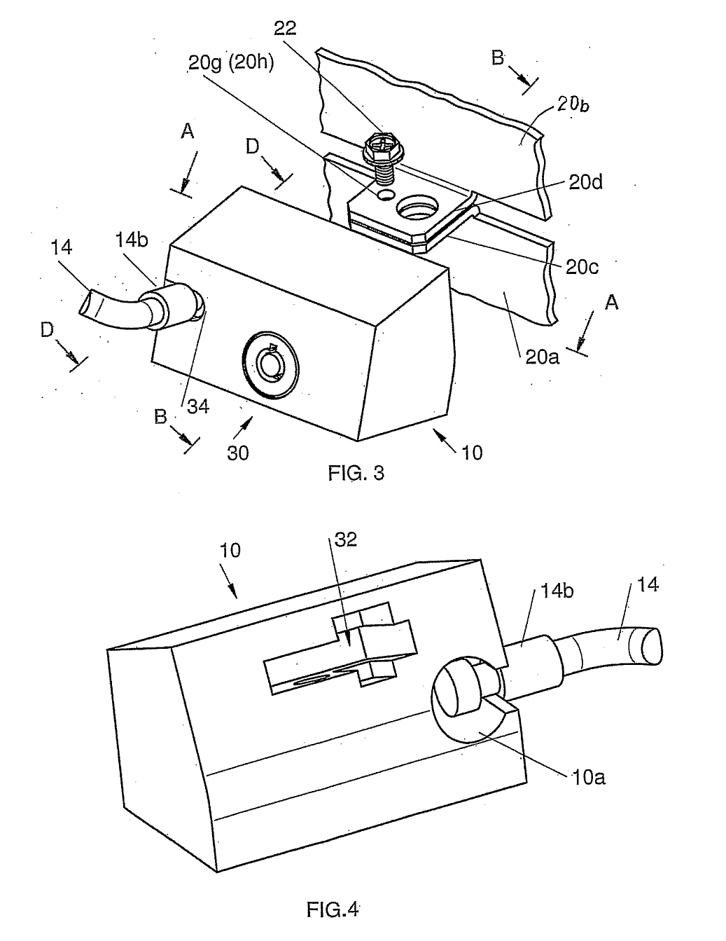

As better seen in FIG. 3 the desktop computer casing 20 has a hinged or otherwise removable cover portion 20a and a main portion 20b, each provided with ears 20c and 20d formed with an opening 20e and 20f, respectively (see FIG. 5a).

Optionally, there are formed in the ears 20c and 20d a pair of additional aligned bores 20g and 20h for the passage of bolt 22 therethrough (see below)

Turning now to the lock-body 10 as more clearly seen in FIGS. 4, 5a and 5b, there is provided a lock mechanism 30 of any conventional type which includes a rotor rotatable by the key 12 between locked and unlocked positions when turned 180°.

The lock-body is further formed with a cavity or recess 32 configured to receive both ears 20c and 30d, as well as the bolt 22 after being passed through the bores 20g and 20h.

The slot 10a which is formed at a side-wall of the lock-body 10 is adapted to secure thereinside the head 14b of the cable 14 before mounting are arresting the locking device as will be explained below.

As shown in FIGS. 5a and 5b, rotor 36 of the locking mechanism 30 carries a disc 38, provided with an accenter to toggle pin 40. The pin 40 is coupled to a reciprocable block 42 carrying a lock pin 44. The toggle pin 40 is coupled to the block 42 via guide slot 46 enabling the rotation of the toggle pin 40 to lift and lower the block 42.

The first locking stage comprises the insertion of the cable-head 14b into and along the groove 10a as seen in FIG. 4, into the position shown in FIG. 3, after the other end of the cable 14 has been looped around a fixed object such as the table leg 16.

The next stage of arresting the lock-body to the computer casing is depicted in FIG. 6, namely by abutting the lock-body against the lock wall 20a of the computer so that the ears 20c and 20d, optionally along with the bolt 22 (FIG. 3) passed through the opening 20g and 20f, are fully received within the cavity 32.

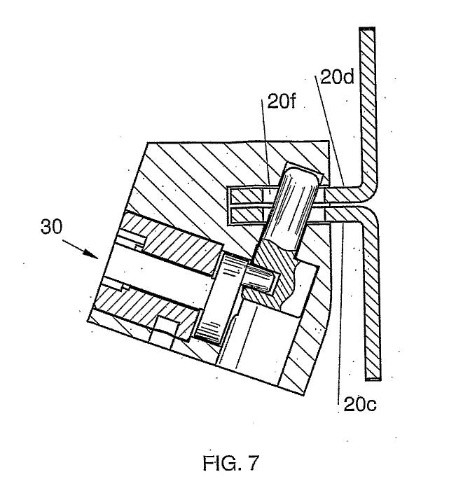

Then, by turning the key 12 by 180°, the toggle pin 40 drives the block 42 in a sliding linear movement so that the lock pin 44 enters cavity 32, passing through the openings 20e and 20f of the ears 20c and 20d, respectively, thereby completing the locking operation, as shown in FIG. 7.

Those skilled in the art, will readily appreciate that the invention has been described hereabove with reference to a specific embodiment. However, this is not the only example and embodiment in which the invention may be practiced. Indeed, various modifications may be made to the above-described example and embodiment without departing from the intended spirit and scope of the present invention, and it is intended that all such modifications be included within the scope of the following claims.

What is claimed is:

1. A locking device for box-shaped containers having a base and a separable cover each provided with an ear-like extension having an opening, wherein in the lockable position the openings are in register one with respect to the other and the container becomes locked by insertion of a locking element through both openings, the device comprising;
(a) a block-shaped housing;
(b) a key-operated rotor installed within the housing;
(c) a slidable locking element coupled to the rotor so that upon rotation of the rotor by 180° in one or the opposite directions by turning the key, the locking element slides over a certain distance in one or the opposite directions normally to the axial direction of the rotor; and
(d) a cavity formed in the housing configured to accommodate therein both said ear-like extensions when in overlapping position,
the arrangement being such that for locking the container, the locking element is driven in the direction of and across said cavity and openings, and for unlocking, the locking element is driven in the opposite direction out of the said cavity.

2. The device as claimed in claim 1 wherein the ear-like extensions are formed with second openings in register one with respect to the other for the insertion therethrough a bolt, said cavity being configured to receive therein the inserted bolt.

3. The device as claimed in claim 1 or 2, wherein the rotor is rotatable by a key mechanism, the rotor being coupled to the locking element via a toggle pin slidably received in a slot formed in a reciprocable block.

4. The device as claimed in claim 3 further comprising a security cable attachable to the housing by one end thereof whereas the other end is adapted to looped around a stationary object.

5. The device as claimed in claim 4, wherein said one end of the cable is provided with a cable-head fit to be inserted into a groove formed at a side-wall of the housing to become self-arrested in the mounted position of the housing.
